(19) United States
(12) Patent Application Publication
(10) Pub. No.: US 2025/0242445 A1
(43) Pub. Date: Jul. 31, 2025

(54) SUBSTRATE HOLDER

(71) Applicant: Applied Materials, Inc., Santa Clara, CA (US)

(72) Inventors: Jean Delmas, Santa Clara, CA (US); Bernhard Wolfgang Stonas, Hayward, CA (US); Steven Verhaverbeke, San Francisco, CA (US); Kurtis Siegfried Leschkies, San Jose, CA (US); Sumedh Acharya, Bengaluru (IN); Dakshalkumar Kantilal Patel, Bengaluru (IN)

(21) Appl. No.: 19/032,966

(22) Filed: Jan. 21, 2025

Related U.S. Application Data
(60) Provisional application No. 63/627,679, filed on Jan. 31, 2024.

(51) Int. Cl. B23K 26/382; B23K 26/142; B23K 37/04

(52) U.S. Cl. CPC B23K 26/382; B23K 26/142; B23K 37/0426

(57) ABSTRACT

A substrate holder includes a chuck base forming a chucking vacuum line and a particle vacuum line. The particle vacuum line is to extract particles produced from substrate processing. The substrate holder further includes one or more chuck posts extending from an upper surface of the chuck base. The chucking vacuum line is routed through the one or more chuck posts to chuck a substrate. The substrate holder further includes one or more die collect components disposed on the upper surface of the chuck base. A device is to be supported by at least one of the one or more die collect components responsive to being cut from the substrate.

### RELATED APPLICATION

This application claims benefit of U.S. Provisional Application No. 63/627,679, filed Jan. 31, 2024, the contents of which are incorporated by reference in their entirety herein.

### TECHNICAL FIELD

Embodiments of the present disclosure relate to holders, such as those used in association with substrate processing systems, and in particular to a substrate holder.

### BACKGROUND

In substrate processing and other electronics processing, products undergo different operations, such as laser processing and dicing.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a substrate holder includes a chuck base forming a chucking vacuum line and a particle vacuum line. The particle vacuum line is to extract particles produced from substrate processing. The substrate holder further includes one or more chuck posts extending from an upper surface of the chuck base. The chucking vacuum line is routed through the one or more chuck posts to chuck a substrate. The substrate holder further includes one or more die collect components disposed on the upper surface of the chuck base. A device is to be supported by at least one of the one or more die collect components responsive to being cut from the substrate.

In another aspect of the disclosure, a substrate holder includes a chuck base forming a chucking vacuum line and a particle vacuum line. The particle vacuum line is to extract particles produced from substrate processing. The substrate holder further includes an annular chuck post extending from an upper surface of the chuck base. The chucking vacuum line is routed through the annular chuck post to chuck a substrate.

In another aspect of the disclosure, a method includes causing a substrate to be disposed on one or more chuck posts that extend from an upper surface of a chuck base of a substrate holder. The chuck base forms a chucking vacuum line. The chucking vacuum line is routed through the one or more chuck posts. The method further includes causing the substrate to be secured on the one or more chuck posts by suction through the chucking vacuum line. The method further includes causing a device to be laser cut from the substrate. The device is to be supported by at least one die collect component responsive to being cut from the substrate.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a cross-sectional view of a system including a substrate holder, according to certain embodiments.

FIGS. 2A-G illustrate substrate holders, according to certain embodiments.

FIGS. 3A-C illustrate substrate holders, according to certain embodiments.

FIGS. 4A-D illustrate substrates formed using substrate holders, according to certain embodiments.

FIG. 5 illustrates a flow diagram of a method of using a substrate holder, according to certain embodiments.

### DETAILED DESCRIPTION OF EMBODIMENTS

Embodiments described herein are related to a substrate holder (e.g., substrate holder for laser processing and dicing, substrate holder that allows for dual sided devices processing, substrate holder that prevents device damage or contamination by the laser and redisposition of processed material). The substrate holders can be used for substrate processing (e.g., stress relieving dicing for improved reliability).

In substrate processing and other electronics processing, products undergo operations, such as laser processing and dicing. Conventionally, substrate processing has a laser impact on the substrate support assembly (e.g., the electrostatic chuck) and reflects onto the substrate (e.g., die). The laser impact on the substrate support assembly damages the substrate support assembly and generates particles that causes substrate irregularities and increased cleaning operations. The laser reflecting onto the substrate also causes reflection damage on the substrate. The damage to the substrate support assembly and the substrates causes more downtime of substrate processing equipment, decreased yield, substrate irregularities, increased material waste, increased energy consumption, increased cleaning operations, increased maintenance, increased user time, etc.

Conventionally, dicing of substrates (e.g., silicon dies, active chips, substrates, interposers) with an added epoxy layer has high stress build up leading to mechanical failure of the die (e.g., cracks) and poor reliability. This also leads to decreased yield, substrate irregularities, increased material waste and energy consumption, etc.

The components, assemblies, systems, and methods disclosed herein provide solutions to these and other problems of conventional systems.

A substrate holder includes a chuck base forming a chucking vacuum line and a particle vacuum line. The particle vacuum line is used to extract particles produced from substrate processing. The substrate holder further includes one or more chuck posts extending from an upper surface of the chuck base. The chucking vacuum line is routed through the one or more chuck posts to chuck a substrate. The substrate holder further includes one or more die collect components disposed on the upper surface of the chuck base. A device (e.g., die) is to be supported by at least one of the one or more die collect components responsive to being cut from the substrate.

In some embodiments, the substrate holder can be used for dicing (e.g., laser cutting) of substrates to allow stress relieving and increased reliability and yield in dies (e.g., devices) that are removed from the substrates. The present disclosure may include dicing via laser and/or plasma (e.g., laser scribing followed by plasma etch). The dicing of the present disclosure may reduce concentration of stresses at the corner of the die by having round corner (e.g., distributed stress) or hollowed-out corners filled with epoxy (e.g., buffer corner). To produce the hollowed-out corners, four holes (e.g., four corners of a rectangle or square) may be formed from an upper surface to a lower surface of a substrate, material (e.g., epoxy) may be inserted in the four holes, and then a device may be cut from the substrate where each corner of the device corresponds to a substantial center of each of the holes.

The components, systems, and methods disclosed herein have advantages over conventional solutions. The substrate holder of the present disclosure is configured to avoid damage from laser impact and reduce reflection damage to substrates compared to conventional systems. This allows the present disclosure to have less downtime, increased yield, less substrate irregularities, decreased material waste, decreased energy consumption, decreased cleaning operations, decreased maintenance, decreased user time, etc. compared to conventional systems. The methods of the present disclosure are configured to produce dies (e.g., devices) that have less mechanical failure, less cracks, increased reliability, increased yield, less irregularities, decreased material waste, decreased energy consumption, etc.

Although some embodiments of the present disclosure are described with substrate holders used in substrate processing, in some embodiments, substrate holder can be used with processing of other products.

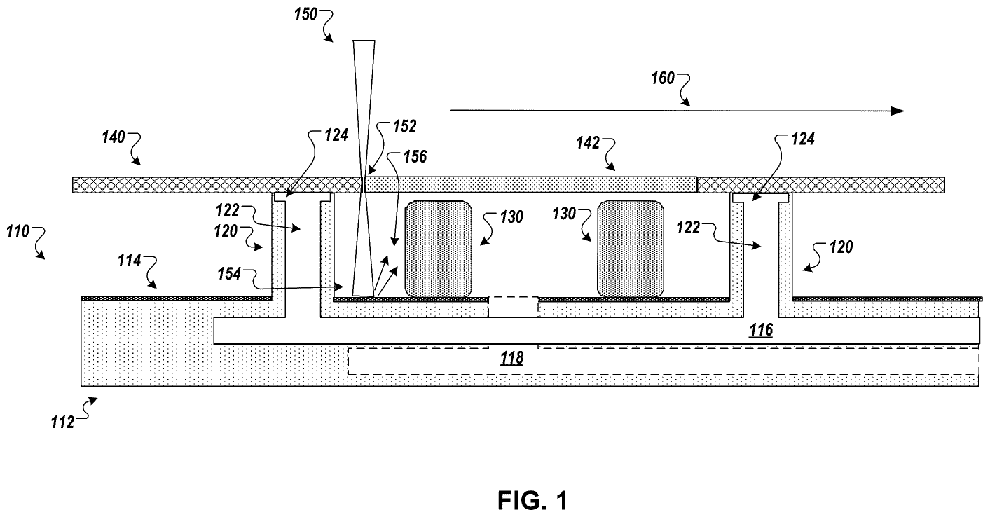

FIG. 1 is a cross-sectional view of a system 100 including a substrate holder 110, according to certain embodiments. The substrate holder 110 includes a chuck base 112, one or more chuck posts 120 (e.g., vacuum chuck, vacuum port), and one or more die collect components 130. The system 100 further includes a substrate 140 disposed on the substrate holder 110.

A substrate holder 110 includes a chuck base 112 that forms a chucking vacuum line 116 (e.g., vacuum line for chucking) and a particle vacuum line 118 (e.g., vacuum line for particle/device 142 collect). The particle vacuum line 118 is to extract particles (e.g., portions of substrate produced by laser cutting, dust, etc.) produced during substrate processing (e.g., laser cutting, dicing, plasma operations, etc.).

One or more chuck posts 120 extend from an upper surface 114 (e.g., rough surface layer, upper surface that has an optical coefficient that meets a threshold optical coefficient) of the chuck base 112. The chucking vacuum line 116 is routed through the one or more chuck posts 120 to chuck a substrate 140.

The one or more die collect components 130 are disposed on an upper surface 114 of the chuck base 112. In some embodiments, a feature (e.g., protrusion, recess) on a lower surface of the die collect component 130 is configured to interface with a feature (e.g., recess, protrusion) of an upper surface 114 of the chuck base 112.

A device 142 (e.g., die, dual-sided device) is to be supported by at least one of the one or more die components 130 responsive to being cut from the substrate 140. In some embodiments, the one or more die collect components 130 are made of thermoplastic. In some embodiments, the one or more die collect components 130 are a single die collect component 130 that is substantially annular and surrounds a port (e.g., surrounded by upper surface 114 of chuck base 112) of the particle vacuum line 118.

In some embodiments, at least a portion of the upper surface 114 (e.g., upper surface layer, rough upper surface layer) of the chuck base 112 is configured to dissipate and/or randomize laser reflection.

In some embodiments, the device 142 is to be cut from the substrate 140 via a laser 150. The laser 150 may focus at location 152 (e.g., proximate the substrate 140 and device 142, at focus when processes substrate) when processing substrate 140. The laser 150 may be defocused at location 154 (e.g., defocused when impact chuck) when impacting the chuck base 112 (e.g., when impacting upper surface 114). Spacing between the substrate 140 and the chuck base 112 is to prevent reflection 156 (e.g., low impact randomized reflection) of the laser 150 from impacting the device 142 (e.g., and to prevent reflection 156 from impacting substrate 140).

In some embodiments, the one or more chuck posts 120 may include a first chuck post 120 configured to support a first portion of the substrate 140 and a second chuck post 120 configured to support a second portion of the substrate 140.

In some embodiments, the one or more chuck posts 120 include a single chuck post 120 (e.g., annular chuck post 120) that supports a first portion and a second portion of the substrate 140 (e.g., the first and second portions being opposite each other). In some embodiments, the single chuck post 120 is substantially annular. The single chuck post 120 may include an outer sidewall and an inner sidewall, where the chucking vacuum line 116 (e.g., chucking vacuum line lower channel 122 and chucking line upper channel 124) is formed between the outer sidewall and the inner sidewall.

In some embodiments, the chuck post 120 forms a chucking vacuum line lower channel 122 that has a first width and a chucking vacuum line upper channel 124 that has a second width that is greater than the first width. The chucking vacuum line lower channel 122 may be a bore and the chucking line upper channel 124 may be a counterbore. The chucking vacuum line upper channel 124 having a greater width may provide suction on a greater surface area of a lower surface of the substrate 140.

In some embodiments, the substrate holder 110 is configured to produce a device 142 (e.g., die) that has rounded corners. In some embodiments, the substrate holder 110 is configured to produce a device 142 (e.g., die) that has hollowed corners filled with an epoxy.

In some embodiments, the substrate holder 110 forms multiple chucking vacuum lines 116 that are routed to different chuck posts 120. In some embodiments, the substrate holder 110 forms multiple particle vacuum lines 118 that are routed to different ports at the upper surface 114 of the chuck base 112. In some embodiments, the chucking vacuum line 116 and the particle vacuum line 118 are a combined vacuum line. In some embodiments, the chucking vacuum line 116 and the particle vacuum line 118 are separate vacuum lines.

Substrate holder 110 may be used for laser processing and dicing of substrates 140. The substrate holder 110 may allow for processing of dual-sided devices 142. The substrate holder 110 may prevent damage to device 142. The substrate holder 110 may prevent contamination by the laser 150 and redisposition of processed material.

The substrate holder 110 may be used for laser processing of flat substrates (e.g., wafers) and may prevent back-contamination of the device 142 from particles ejected by the laser 150. The substrate holder 110 may allow processing of dual-sided devices 142 while preventing contamination by particle redeposition. In some embodiments, cleaning after dicing using substrate holder 110 is not needed.

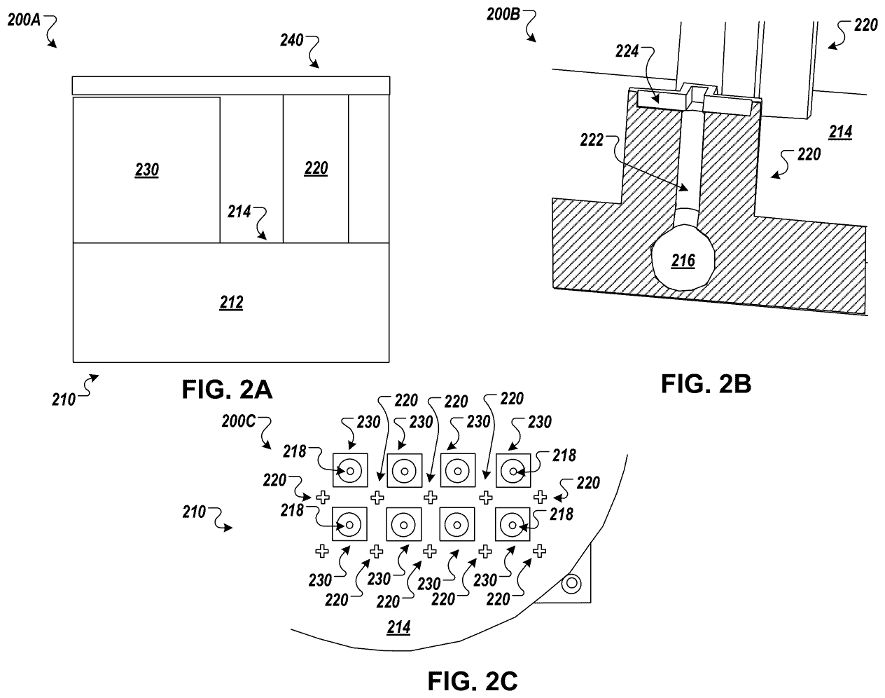

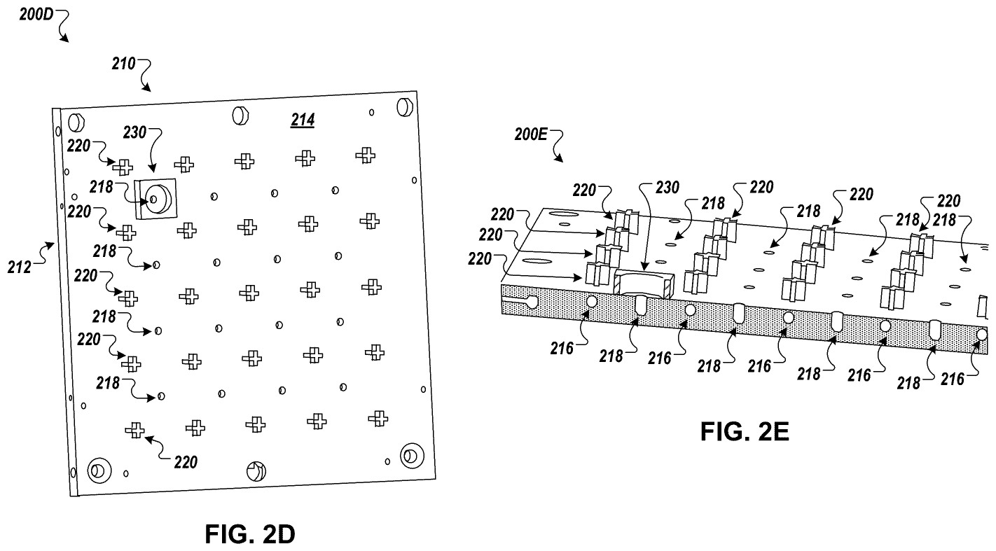

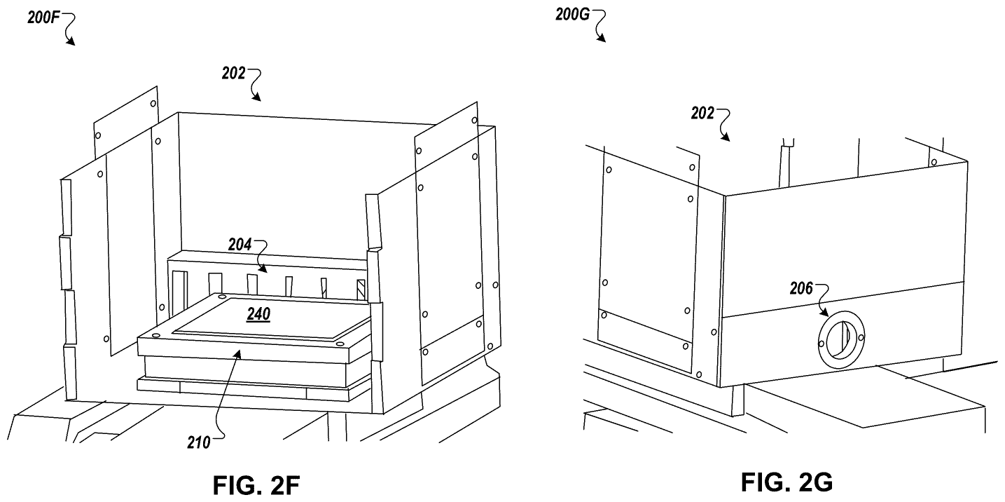

The substrate holder 110 may take into account the laser impact of laser 150 on the chuck base 112. The substrate holder 110 may have a recessed structure (e.g., chuck posts 120 provide a gap between the substrate 140 and the upper surface 114 of chuck base 112) to minimize reflection. The substrate holder 110 may integrate particle removal on top and bottom of the substrate 140 (e.g., wafer), the die catching (e.g., die collection component 130), and wafer chucking features (e.g., chuck posts 120, chucking vacuum line 116) may be based on full wafer layout of substrate 140. The substrate holder 110 may provide particle removal on top via airflow 160 (e.g., provided by structure 202 of FIG. 2F and/or FIG. 2G, air flow for particle extraction) and on bottom via particle vacuum line 118.

In some embodiments, the substrate holder 110 may be used for use of a laser for dicing dual-sided devices 142. In some embodiments, any shape of device 142 and/or substrate 140 may be used with the substrate holder 110. In some embodiments, the substrate holder 110 has higher process control (e.g., highly valuable for heterogenous materials stack) compared to conventional solutions. In some embodiments, the substrate holder 110 imparts lower stress in the device 142 (e.g., part). In some embodiments, the substrate holder 110 enables selective dicing.

In some embodiments, the substrate holder 110 produces devices 142 that have less material redeposition (e.g., on both sides, from laser ablated material) compared to conventional systems. In some embodiments, the substrate holder 110 produces devices 142 that have less backside contamination (e.g., from carrier) compared to conventional systems. In some embodiments, the substrate holder 110 provides collection of the device 142 (e.g., die) without dicing tape.

In some embodiments, the substrate holder 110 is a laser processing chuck. In some embodiments, the substrate holder 110 is a three-dimensional (3D) printed chuck. In some embodiments, the chuck base 112 forms vacuum zones (e.g., via chuck posts 120) to reduce leak impact. In some embodiments, substrate holder 110 includes a dedicated vacuum (e.g., via particle vacuum line 118) for dust extraction under the substrate 140 and die catch (e.g., die collection component 130). In some embodiments, the substrate holder 110 has an upper surface 114 that has a rough surface finish to dissipate and/or randomize laser reflection. This may have cause low damage or no damage on the chuck base substrate holder 110. This may cause no reflection damage on the device 142 (e.g., die). In some embodiments, the chuck post 120 is a hollowed-out wafer holder standoffs for high area chucking. In some embodiments, the chuck posts 120 have wafer holder standoffs location and/or design based on layout of devices 142. This may provide a “no touch device” approach that allows dual-sided wafers processing. In some embodiments, wafer holder standoffs height of chuck post 120 may allow for laser de-focusing and low energy impact on bottom of the chuck base 112. In some embodiments, there is low energy impact on chuck base 112 so that the chuck base 112 is not damaged and material from the chuck base 112 may not redeposit on backside of substrate 140 and device 142.

In some embodiments, the die collection component 130 (e.g., die catch feature) is made of a softer material (e.g., softer than metal, softer than chuck base 112 and/or chuck post 120, acetal, polyoxymethylene (POM), high-performance acetal resin, thermoplastic) to avoid damage (e.g., scratches) of the device 142. In some embodiments, the die collection component 130 (e.g., die catch feature) is recessed for no-contact processing and is close enough to avoid damage of the device 142 (e.g., die) during drop in (e.g., about 10-100 micrometers (μm), about 25-75 μm, about 40-60 μm, about 50 μm). The die collection component 130 may have a height that prevents the device 142 from dropping during processing and that does not induce poor vacuum or backside scratches.

In some embodiments, chuck base 112 and/or chuck post 120 is an electrostatic chuck that is configured to electrostatically chuck the substrate 140.

In some embodiments, chuck base 112 includes a protection layer (e.g., upper surface 114 is a protection layer) configured to shield the chuck base 112 during laser processing.

In some embodiments, the substrate holder 110 is used at atmosphere to allow vacuum to secure the substrate 140 to the chuck posts 120.

FIGS. 2A-G illustrate systems 200A-G including substrate holders 210 (e.g., substrate holder 110 of FIG. 1), according to certain embodiments. FIG. 2A is a side view of a system 200A including a substrate holder 210. FIG. 2B is a side perspective cross-sectional view of a system 200B including a substrate holder 210. FIG. 2C is an upper view of a system 200C including a substrate holder 210. FIG. 2D is an upper perspective view of a system 200D including a substrate holder 210. FIG. 2E is a side perspective cross-sectional view of a system 200E including a substrate holder 210. FIG. 2F is a front perspective view of a system 200F including an X 202 including a substrate holder 210. FIG. 2G is a rear perspective view of a system 200G including an X 202 including a substrate holder 210.

System 200 may include substrate holder 210 and a substrate 240 (e.g., substrate 140 of FIG. 1) disposed on substrate holder 210. Substrate holder 210 may include a chuck base 212 (e.g., chuck base 112 of FIG. 1), chuck posts 220 (e.g., chuck posts 120 of FIG. 1) extending from upper surface 214 (e.g., upper surface 114 of FIG. 1) of chuck base, die collection components 230 (e.g., die collection components 130 of FIG. 1) disposed on the chuck base 212.

In some embodiments, chuck post 220 has a plus-sign shape (e.g., cross-shape, x-shape, etc.) the chucking vacuum line lower channel 222 (e.g., chucking vacuum line lower channel 122 of FIG. 1) may be disposed in the center of the plus-sign shape and the chucking line upper channel 224 (e.g., chucking line upper channel 124 of FIG. 1) may form a plus-sign within the plus-sign shape. This allows the substrate holder 210 to provide suction in a plus-sign shapes on a lower surface of the substrate 240.

In some embodiments, the die collection component 230 has a substantially rectangular (e.g., square) outer perimeter and forms a substantially circular inner perimeter around a port of the particle vacuum line 218. In some embodiments, one or more devices (e.g., dies), each disposed above a corresponding die collection component 230, are to be removed from substrate 240 and are to fall onto (e.g., be disposed on) the corresponding die collection components 230. The particle vacuum line 218 is to remove particles produced from the removing of the devices from the substrate 240.

Referring to FIGS. 2F-G, in some embodiments, system 200 includes a structure 202 (e.g., enclosure, shroud, chamber, sheet metal enclosure, etc.) that partially encloses substrate holder 210 and substrate 240 (e.g., wafer). Airflow may be provided from within the structure 202 through flow control component 204 (e.g., flow control sheet metal piece) and out outlet 206 (e.g., that has suction of about 50-250 cubic feet per minute (CFM), of about 100-200 CFM, of about 125-175 CFM, of about 150 CFM, etc.). Laser operations may be performed from above (e.g., structure 202 may not have an upper wall, laser coming from the top). A robot (e.g., end effector, factory interface robot, etc.) may provide the substrate 240 on the substrate holder 210 through the front of the structure 202 (e.g., structure 202 may not have a front wall). Structure 202 may have a rear wall, a first sidewall, and a second sidewall. The airflow through structure 202 may remove particles produced during substrate operations.

In some embodiments, system 200 is used for laser processing with particle removal. In some embodiments, system 200 provides substantially uniform flow pattern and velocity across the whole substrate (e.g., within about 1 meter per second (m/s)). In some embodiments, airflow is controlled by the structure 202 (e.g., enclosure) and flow control component 204 (e.g., slotted showerhead). In some embodiments, system 200 has no lens or window for laser so no cleaning is needed and/or there is no loss of laser power.

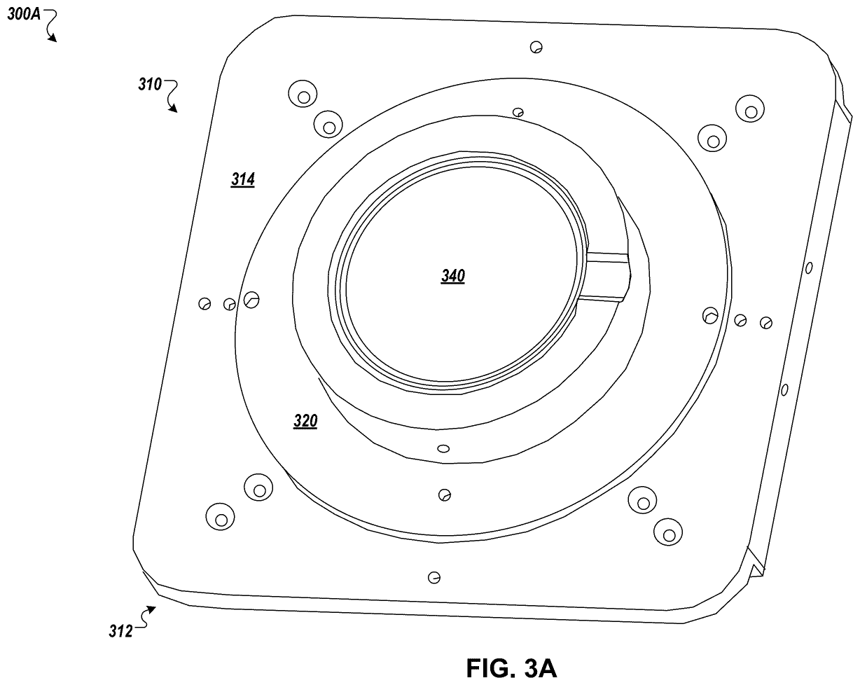

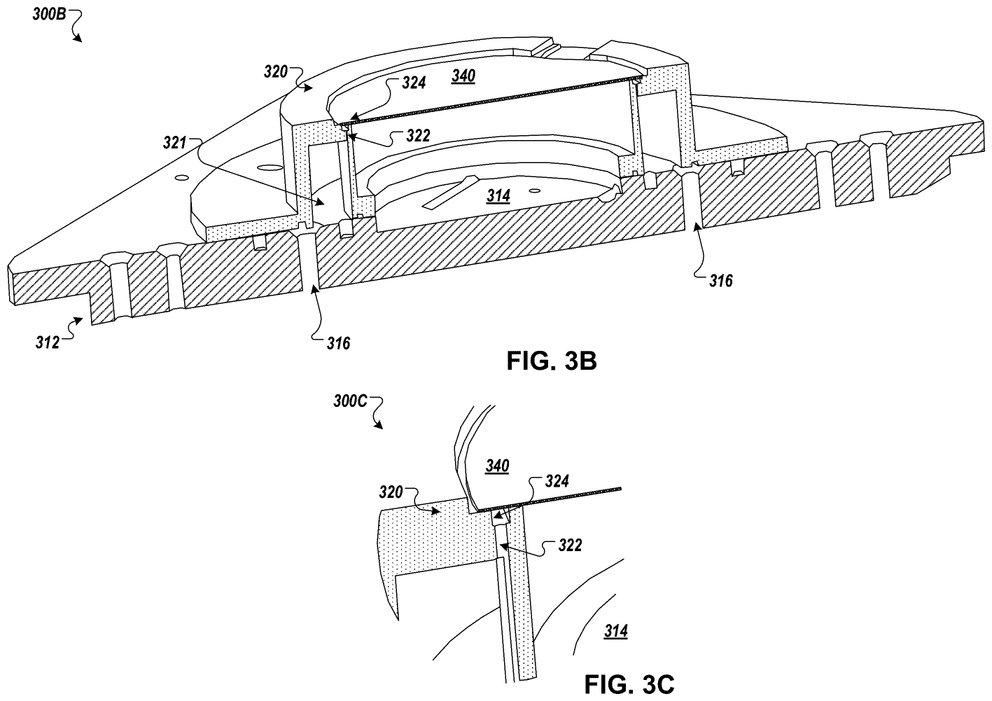

FIGS. 3A-C illustrate systems 300A-C including substrate holders 310 (e.g., substrate holder 110 of FIG. 1, substrate holder 210 of one or more of FIGS. 2A-G), according to certain embodiments. FIG. 3A is an upper perspective view of system 300A including substrate holder 310. FIG. 3B is a side perspective cross-sectional view of system 300B including substrate holder 310. FIG. 3C is a side perspective cross-sectional view of system 300B including substrate holder 310.

In some embodiments, the chuck post 320 is a single annular chuck post 320. The chuck post 320 may be coupled (e.g., attached, fastened, welded, soldered, adhered, integral, etc.) to chuck base 312. Substrate 340 may be disposed on the chuck post 320. The chuck post 320 may support a perimeter portion of the substrate 340.

The chuck post 320 may form a chucking vacuum line lower channel 322 (e.g., slot, pin hole, chucking vacuum line lower channel 122 of FIG. 1, chucking vacuum line lower channel 222 of FIG. 2B) that has a first width and a chucking vacuum line upper channel 324 (e.g., groove, chucking groove, exclusion zone, chucking vacuum line upper channel 124 of FIG. 1, chucking line upper channel 224 of FIG. 2B) that has a second width that is greater than the first width. The chuck post 320 may further form a plenum 321 (e.g., large vacuum plenum). The plenum 321 may be disposed between the chucking vacuum line lower channel 322 (e.g., slot) and the chucking vacuum line 316 formed by chuck base 312. The chucking vacuum line upper channel 324 (e.g., groove) may be disposed between the chucking vacuum line lower channel 322 and substrate 340.

In some embodiments, the substrate holder 310 has an edge grip with a custom insert (e.g., chuck post 320). The chuck post 320 (e.g., custom insert) may be placed in the center (e.g., centered over a port of the particle vacuum line 118) for device collection for a dicing process. In some embodiments, substrate holder 310 may allow switching (e.g., cheaper and/or faster) from one die layout to another.

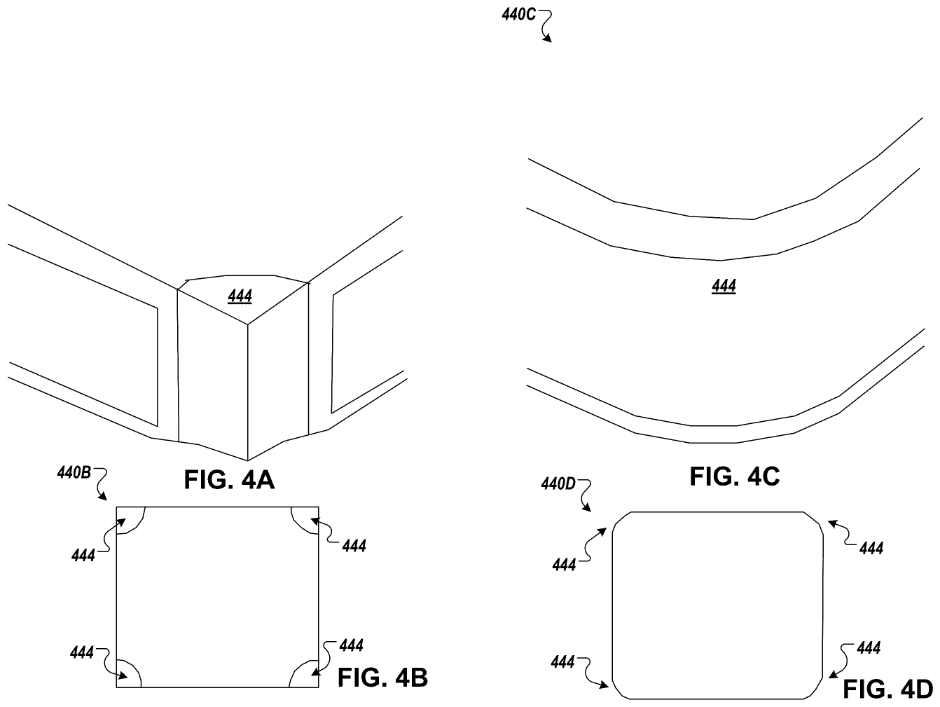

FIGS. 4A-D illustrate substrates 440 formed using substrate holders (e.g., substrate holder 110 of FIG. 1, substrate holder 210 of one or more of FIGS. 2A-G, substrate holder 310 of one or more of FIGS. 3A-C), according to certain embodiments.

Substrate 440A of FIG. 4A and substrate 440B of FIG. 4B have corners 444 that are hollowed corners filled with epoxy (e.g., corner via filled with epoxy). In some embodiments, corner filled with epoxy is about 200-600 μm, about 300-500 μm, about 350-450 μm, or about 400 μm.

Substrate 440C of FIG. 4C and substrate 440D of FIG. 4D have corners 444 that are rounded corners (e.g., corner blend). In some embodiments, corner blend is about 200-600 μm, about 300-500 μm, about 350-450 μm, or about 400 μm.

The substrate holder of the present disclosure may provide stress relieving dicing for improved reliability.

The substrate holder may provide a layout and method of dicing after redistribution layer (RDL) buildup to allow full stress relieving and increased reliability and yield in the dies (e.g., devices).

In conventional dicing (e.g., mechanical dicing, saw dicing, non-stress relieving pattern dicing), silicon dies (e.g., active chips, substrates, and/or interposers) that have added-on RDL layers (e.g., epoxy) have high stress build up, leading to mechanical failure of the die (e.g., cracks) and poor reliability. In some embodiments of the present disclosure, the dicing method may have reduced stresses compared to conventional methods and may increase reliability and yield.

In some embodiments, the present disclosure provides dicing using laser (e.g., laser dicing), plasma (e.g., plasma dicing), or a combination of both (e.g., laser scribing followed by plasma etch). The present disclosure (e.g., the pattern of the present disclosure) may reduce concentration of stresses at the corner of the die by either having round corner (e.g., distributed stress) or hollowed-out corners filled with epoxy (e.g., like a buffer corner).

In some embodiments, substrate 440 may be produced via stress relieving dicing method for improved reliability compared to conventional substrates.

Integrated circuit (IC) packaging may include different layered materials (e.g., silicon (Si) and epoxy, glass and epoxy, Si and polyimide, and/or other combinations). These materials may have different thermal expansion coefficients (CTE). The stresses driven by these CTE differences may be present in the stack (e.g., from manufacturing processes, operating temperature, etc.). Other mechanical stresses may also be present in substrates. Stresses may tend to be higher at material interface and at corners of conventional devices (e.g., conventional dies). Conventional dicing (e.g., square grid pattern, via mechanical (saw) dicing, or other techniques (laser and/or plasma)) may lead to devices (e.g., dies) with high embedded stress. Conventional dicing may lead to failure (e.g., cracks) in the device (e.g., die).

In some embodiments, substrates 440 of the present disclosure are produced by dicing pattern reducing or displacing high stress areas to increase die reliability. In some embodiments, substrates 440 of the present disclosure have rounded corners that have lower overall stress at the corner 444, leading to less failures. In some embodiments, substrates 440 of the present disclosure have hollowed corners that have stress displacement to inner part of the die leading to more robust die side, protected by epoxy or other material.

In some embodiments, substrates 440 are formed by a dicing technique, such as laser dicing (e.g., ultraviolet (UV) dicing, infrared radiation (IR) dicing, carbon dioxide (CO₂) dicing, green dicing, etc.) and/or plasma dicing. The laser dicing may be performed with speed and delay management.

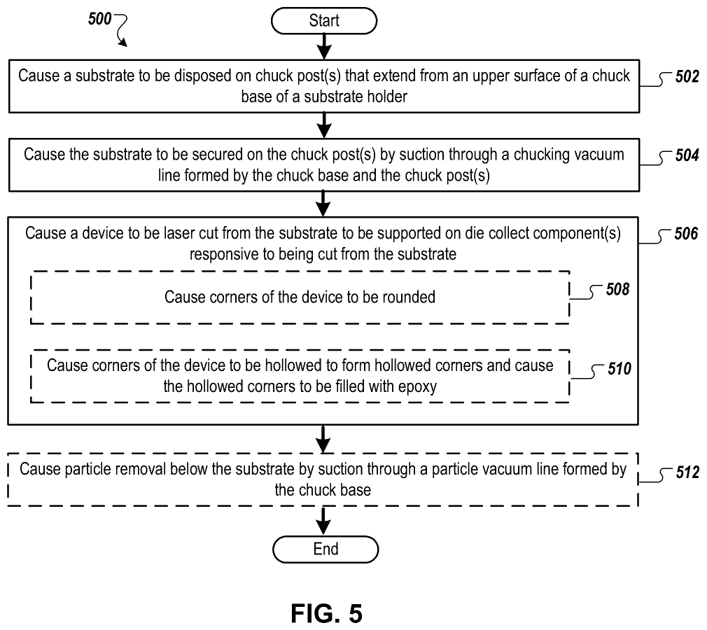

FIG. 5 illustrates a method of using a substrate holder (e.g., substrate holder 110 of FIG. 1, substrate holder 210 of one or more of FIGS. 2A-G, substrate holder 310 of one or more of FIGS. 3A-C), according to certain embodiments. In some embodiments, one or more of operations of method 500 are performed by a controller. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment.

Referring to method 500 of FIG. 5, at block 502, a substrate (e.g., substrate 140 of FIG. 1) is caused to be disposed on one or more chuck posts (e.g., chuck post 120 of FIG. 1) that extend from an upper surface (e.g., upper surface 114 of FIG. 1) of a chuck base (e.g., chuck base 112 of FIG. 1) of a substrate holder (e.g., substrate holder 110 of FIG. 1).

At block 504, the substrate is caused to be secured on the one or more chuck posts by suction through a chucking vacuum line (e.g., chucking vacuum line 116 of FIG. 1) formed by the chuck base and the one or more chuck posts.

At block 506, a device (e.g., device 142 of FIG. 1) is caused to be laser cut from the substrate to be supported on one or more die collect components (e.g., die collect component 130 of FIG. 1) responsive to being cut from the substrate.

In some embodiments, block 506 includes block 508 and/or block 510.

At block 508, corners of the device are caused to be rounded (e.g., see FIGS. 4C-D).

At block 510, corners of the device are caused to be hollowed to form hollowed corners and the hollowed corners are caused to be filled with epoxy (e.g., see FIGS. 4A-B).

In some embodiments, at block 512, particle removal is caused below the substrate by suction through a particle vacuum line (e.g., particle vacuum line 118 of FIG. 1) formed by the chuck base.

Unless specifically stated otherwise, terms such as “causing,” “transmitting,” “providing,” “laser cutting,” “determining,” “receiving,” “generating,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein, or it includes a general-purpose computer system selectively programmed by a computer program stored in the computer system. In some embodiments, such a computer program is stored in a computer-readable tangible storage medium.

The methods and illustrative examples described herein are not inherently related to any particular computer or other apparatus. Various general-purpose systems can be used in accordance with the teachings described herein, or a more specialized apparatus can be constructed to perform methods described herein and/or each of their individual functions, routines, subroutines, or operations. Examples of the structure for a variety of these systems are set forth in the description above.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure can be practiced without these specific details. In other instances, well-known components or methods are not described in detail or are presented in simple block diagram format in order to avoid unnecessarily obscuring the present disclosure. Thus, the specific details set forth are merely exemplary. Particular implementations can vary from these exemplary details and still be contemplated to be within the scope of the present disclosure.

The terms “over,” “under,” “between,” “disposed on,” “support,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of operations of each method can be altered so that certain operations are performed in an inverse order so that certain operations are performed, at least in part, concurrently with other operations. In another embodiment, instructions or sub-operations of distinct operations are in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A substrate holder comprising:
a chuck base forming a chucking vacuum line and a particle vacuum line, the particle vacuum line to extract particles produced from substrate processing;
one or more chuck posts extending from an upper surface of the chuck base, the chucking vacuum line being routed through the one or more chuck posts to chuck a substrate; and
one or more die collect components disposed on the upper surface of the chuck base, wherein a device is to be supported by at least one of the one or more die collect components responsive to being cut from the substrate.

2. The substrate holder of claim 1, wherein at least a portion of the upper surface is configured to at least one of dissipate or randomize laser reflection.

3. The substrate holder of claim 1, wherein the device is to be cut from the substrate via a laser, wherein spacing between the substrate and the chuck base is to prevent reflection of the laser from impacting the device.

4. The substrate holder of claim 1, wherein the one or more chuck posts comprise a first chuck post configured to support a first portion of the substrate and a second chuck post configured to support a second portion of the substrate.

5. The substrate holder of claim 1, wherein the one or more chuck posts comprise a first chuck post that forms a chucking vacuum line lower channel that has a first width and a chucking vacuum line upper channel that has a second width that is greater than the first width.

6. The substrate holder of claim 1, wherein the one or more chuck posts comprise a single chuck post that supports a first portion of the substrate and a second portion of the substrate.

7. The substrate holder of claim 6, wherein the single chuck post is substantially annular, wherein the single chuck post comprises an outer sidewall and an inner sidewall, wherein the chucking vacuum line is formed between the outer sidewall and the inner sidewall.

8. The substrate holder of claim 1, wherein the one or more die collect components are made of thermoplastic.

9. The substrate holder of claim 1, wherein the one or more die collect components is a single die collect component that is substantially annular and surrounds a port of the particle vacuum line.

10. The substrate holder of claim 1, wherein the substrate holder is configured to produce the device that has rounded corners.

11. The substrate holder of claim 1, wherein the substrate holder is configured to produce the device that has hollowed corners filled with an epoxy.

12. A substrate holder comprising:
a chuck base forming a chucking vacuum line and a particle vacuum line, the particle vacuum line to extract particles produced from substrate processing; and
an annular chuck post extending from an upper surface of the chuck base, the chucking vacuum line being routed through the annular chuck post to chuck a substrate.

13. The substrate holder of claim 12 further comprising an annular die collect component disposed on the upper surface of the chuck base, wherein a device is to be supported by the annular die collect component responsive to being cut from the substrate.

14. The substrate holder of claim 13, wherein the device is to be cut from the substrate via a laser, wherein spacing between the substrate and the chuck base is to prevent reflection of the laser from impacting the device.

15. The substrate holder of claim 12, wherein at least a portion of the upper surface is configured to at least one of dissipate or randomize laser reflection.

16. The substrate holder of claim 12, wherein the annular chuck post forms a chucking vacuum line lower channel that has a first width and a chucking vacuum line upper channel that has a second width that is greater than the first width.

17. A method comprising:
causing a substrate to be disposed on one or more chuck posts that extend from an upper surface of a chuck base of a substrate holder, the chuck base forming a chucking vacuum line, the chucking vacuum line being routed through the one or more chuck posts;
causing the substrate to be secured on the one or more chuck posts by suction through the chucking vacuum line; and
causing a device to be laser cut from the substrate, wherein the device is to be supported by at least one die collect component responsive to being cut from the substrate.

18. The method of claim 17 further comprising causing particle removal below the substrate by suction through a particle vacuum line, the chuck base forming the particle vacuum line.

19. The method of claim 17, wherein the causing of the device to be laser cut from the substrate comprises rounding corners of the device.

20. The method of claim 17, wherein the causing of the device to be laser cut from the substrate comprises hollowing corners of the device to form hollowed corners and filling the hollowed corners with epoxy.
